(19) United States
(12) Patent Application Publication
(10) Pub. No.: US 2026/0281019 A1
(43) Pub. Date: Sep. 17, 2026

(54) PLMN CHECK FOR QoE MEASUREMENTS DURING UE MOBILITY IN DIFFERENT RRC STATES

(71) Applicant: Telefonaktiebolaget LM Ericsson (publ), Stockholm (SE)

(72) Inventors: Ali Parichehrehteroujeni, Linköping (SE); Filip Barac, Huddinge (SE); Luca Lunardi, Genova (IT); Cecilia Eklöf, Täby (SE); Johan Rune, Lidingö (SE)

(21) Appl. No.: 19/472,922

(22) PCT Filed: Mar. 27, 2024
(86) PCT No.: PCT/SE2024/050282

§ 371 Date: Oct. 6, 2025

Related U.S. Application Data
(60) Provisional application No. 63/494,673, filed on Apr. 6, 2023.

(51) Int. Cl. H04L 43/0805; H04W 84/04

(52) U.S. Cl. CPC H04L 43/0805; H04W 84/042

(57) ABSTRACT

Systems and methods for enabling a Public Land Mobile Network (PLMN) check for Quality of Experience (QoE) measurement reporting during User Equipment (UE) mobility are disclosed. In one embodiment, a method performed by a UE comprises receiving, from a first network node, a QoE measurement configuration comprising one or more PLMN lists that indicate one or more allowed PLMNs. The method further comprises starting an application session that is subject to the QoE measurement configuration, starting QoE measurements in accordance with the QoE measurement configuration, and transitioning from connected state to idle state. The method further comprises, in the process of transitioning from idle state to connected state with respect to a second network node, obtaining a PLMN Identifier (ID) of the second network node and determining whether that PLMN is an allowed PLMN. The method further comprises operating in accordance with a result of the determining.

### RELATED APPLICATIONS

This application claims the benefit of provisional patent application Ser. No. 63/494,673, filed Apr. 6, 2023, the disclosure of which is hereby incorporated herein by reference in its entirety.

### TECHNICAL FIELD

The present disclosure relates to Quality of Experience (QoE) measurement configuration and reporting in a wireless communication system such as, e.g., a 3^{rd} Generation Partnership Project (3GPP) system.

### BACKGROUND

### Overview of the QoE Framework

Quality of Experience (QoE) measurements, also referred to as “application layer measurements,” have been specified for 3^{rd} Generation Partnership (3GPP) Long Term Evolution(LTE) and Universal Mobile Telecommunications System (UMTS) and were recently specified for 5^{th} Generation (5G) New Radio (NR) in 3GPP Release 17. The purpose of the QoE measurements is to measure the experience of the end user using certain applications. Currently the QoE measurements are specified and supported for Dynamic Adaptive Streaming over Hyper-Text Transfer Protocol (HTTP) (DASH) streaming, Mobility Telephony Service for Internet Protocol (IP) Multimedia Subsystem (IMS) (MTSI) services, and Virtual Reality (VR).

The solutions in LTE and UMTS are similar with the overall principles as follows. QoE Measurement Collection (QMC) enables configuration of application layer measurements in the User Equipment (UE) and transmission of QoE measurement result files, commonly referred to as “QoE reports,” to the network by means of Radio Resource Control (RRC) signaling. An application layer measurement configuration (also called QoE measurement configuration or QoE configuration) that the Radio Access Network (RAN) receives from the Operations, Administration, and Maintenance (OAM) system, or the Core Network (CN), is encapsulated in a transparent container, which is forwarded to a UE in a downlink RRCReconfiguration message. An application layer measurement report (also called QoE report) that the UE Access Stratum (UE AS) or UE RRC layer receives from the UE's higher layer (application layer) is encapsulated in a transparent container and sent to the network in an uplink RRC message, MeasurementAppLayerReport. The RAN then forwards the QoE report to a Measurement Collector Entity (MCE).

In 3GPP Release 17 “Study on NR QoE management and optimizations for diverse services” with the purpose to study solutions for QoE measurements in NR was finalized and concluded. According to this study item, QoE management in NR will not just collect the QoE parameters of streaming services but also consider the typical performance requirements of diverse services (e.g., Augmented Reality (AR)/VR and Ultra-Reliable Low-Latency Communication (URLLC), of which at least VR was covered in 3GPP Release 17). Based on requirements of services, the NR study also included more adaptive QoE management schemes that enable network optimization to satisfy user experience for diverse services.

The configuration data related to QoE measurements (in standard specifications typically referred to as application layer measurements) consists of a service type indication, an indication of an area in which the measurements are to be performed (denoted area scope), an IP address of the entity to which the collected measurement results (i.e. the QoE reports) should be sent (often referred to as a MCE, spelled out as Measurement Collector Entity or Measurement Collection Entity), and a set of instructions of which type of measurements should be performed and details of how these measurements are to be performed. These instructions are intended for the application layer in the UE and are placed in a “container” which cannot be read and interpreted by the network entities handling it, e.g., forwarding it to the UE, as well as the UE Access Stratum. The currently specified service types are MTSI and streaming service (DASH), and in 3GPP Rel-17 , VR was added. An area scope is defined in terms of cells or network related areas. In UMTS, an area scope is defined as either a list of cells, a list of routing areas, or a list of tracking areas. In LTE, an area scope is defined as either a list of cells or a list of tracking areas or a list of Public Land Mobile Networks (PLMNs). In NR, an area scope is defined as either a list of cells (a list of NR Cell Global Identities (NCGIs)) or a list of tracking areas (a list of Tracking Area Codes (TACs)) or a list of PLMNs in which the measurements may proceed.

QoE, and in particular the QoE configuration, comes in two flavors: management-based (m-based) QoE configuration and signaling-based (s-based) QoE configuration. In both cases the QoE configuration originates in the OAM system or some other administrational entity, e.g., dealing with customer satisfaction. All of these entities are referred to herein as the OAM system (where the OAM system also contains further entities).

With the m-based QoE, the OAM system is typically interested in general QoE statistics from a certain area, configured as an area scope. The m-based QoE configuration is sent directly from the OAM system to the RAN nodes controlling cells that are within the area scope. Each RAN node then selects UEs that are within the area scope (and also fulfills any other relevant condition, such as supporting the concerned application/service type) and sends the m-based QoE configuration to these EUs.

With the s-based QoE, the OAM system is interested in collecting QoE measurement results from a specific UE, e.g., because the user of the UE has filed a complaint. The OAM system sends the s-based QoE configuration to the Home Subscriber Server (HSS) (in Evolved Packet System (EPS)/LTE) or Unified Data Management (UDM) (in 5G System (5GS)/NR), which forwards the QoE configuration to the UE's current core network node (CN), e.g. a Mobility Management Entity (MME) in EPS/LTE or an Access and Mobility Management Function (AMF) in 5G/NR. The CN then forwards the s-based QoE configuration to the RAN node that serves the concerned UE and the RAN forwards it to the UE.

Forwarded to the UE are the service type indication and the container with the measurement instructions. The UE is not aware of whether a received QoE configuration is m-based or s-based. In legacy systems, the QoE framework is integrated with the Trace functionality and a Trace Identifier (ID) is associated with each QoE configuration. In NR, the QoE functionality is logically separated from the Trace functionality, but it will still partly reuse the Trace signaling mechanisms. In NR, and possibly in LTE, a globally unique QoE reference (formed of Mobile Country Code (MCC)+Mobile Network Code (MNC)+QoE Measurement Collection (QMC) ID, where the QMC ID is a string of 24 bits) will be associated with each QoE configuration. The QoE reference is included in the container with measurement instructions and also sent to the RAN (i.e., the gNodeB (gNB) in NR). For the communication between the gNodeB (gNB) and the UE, the QoE reference is replaced by a shorter identifier denoted as measConfigAppLayerId, which is locally unique within a UE (i.e., there is a one-to-one mapping between a measConfigAppLayerId and a QoE reference for each QoE configuration provided to a UE). The measConfigAppLayerId is stored in the UE Access Stratum and also forwarded in an AT Command (which is the type of instructions used in the communication between the UE's modem part and the UE's application layer) together with the service type indication and the container with the measurement instructions.

Reports with collected QoE reports are sent from the UE application layer to the UE Access Stratum, which forwards them to the RAN, which in turn forwards them to the MCE. These QoE reports are placed in a “container”, which is uninterpretable for both the UE Access Stratum and the RAN. QoE reporting can be configured to be periodic or only to be sent at the end of an application session. Furthermore, the RAN can instruct the UE to pause QoE reporting, e.g. in case the cell/gNB is in a state of overload.

The RAN is not automatically aware of when an application session with an associated QoE measurement session is ongoing, and the UE Access Stratum is also not automatically aware of this. To alleviate this, session “start”/“stop” indications which are sent from the application layer in the UE to the UE AS and from the UE AS to the RAN were introduced. A session “stop” indication may be explicit or may be implicit in the form of a QoE report sent when the application session and the associated QoE measurement session are concluded.

The RAN may decide to release a QoE configuration in a UE at any time, as an implementation-based decision. Typically, it is done when the UE has moved outside a configured area scope.

One opportunity provided by legacy solutions is also to be able to keep the QoE measurement for the whole session, even during a handover situation. It is also discussed to let the UE continue with the QoE measurements on an ongoing application session until the application session ends, even if the UE in the meantime moves out of the configured area scope.

### RRC States in 5G/NR

In 5G/NR, a UE may be in any of three different RRC states: RRC_CONNECTED state, RRC_INACTIVE state, and RRC_IDLE state. RRC CONNECTED state is the state normally used when the UE is actively communicating. RRC_INACTIVE state and RRC IDLE states are designed to allow the UE to save energy compared to when the UE is in RRC_CONNECTED state.

RRC_IDLE state is the state in which the UE consumes the least energy, When the UE is transferred to RRC IDLE both the UE and the gNB delete the information related to the UE, a.k.a. the UE context, and the gNB thereby saves resources, but it comes at the cost of comparatively long network access time (e.g. transition to RRC_CONNECTED state).

RRC_INACTIVE state has properties that puts it in between the RRC_CONNECTED state and RRC IDLE state. The purpose of the RRC_INACTIVE state is to reduce the signaling overhead over the radio and network interface and to improve the UE access latency (compared to RRC IDLE state) as well as the UE energy consumption. In this state, the Core Network (CN) still regards the UE as connected, thus the CN-RAN connection for the UE is kept active although the RRC connection between the gNB and the UE is suspended. The gNB which maintains the connection to the CN while the UE is in RRC_INACTIVE state is called the Anchor gNB. In order to reduce radio interface signaling at connection establishment, the UE context information is kept in the UE and in the Anchor gNB, which enables the UE to resume its RRC connection when it is paged or has uplink (UL) data or signaling to send. When the CN has user data or control data to send to the UE, the data is sent to the Anchor gNB which then initiates paging of the UE (a.k.a. RAN initiated paging).

### Support for QoE Measurements when the UE is in RRC IDLE State

In 3GPP Release 18, the following has been agreed so far with respect to QE measurements when the UE is in RRC IDLE state:
Both signaling based and management based QoE measurements in RRC INACTIVE/IDLE mode shall be supported in Rel-18.
UE handles area scope checking for QoE measurements in RRC INACTIVE/IDLE mode. Whether UE AS layer or UE APP layer handle the area scope is to be discussed based on RAN2 progress.
Support Multicast/Broadcast Service (MBS) broadcast service INACTIVE/IDLE QoE first.
UE shall keep the QoE configuration for MBS broadcast service configured in RRC CONNECTED even when UE switches to RRC_IDLE and RRC_INACTIVE.
If the UE receives the configuration in RRC connected state, a common QoE configuration mechanism is used to support QoE measurement configuration pertaining to MBS broadcast service for all RRC states, where the Rel-17 QoE configuration mechanism is adopted as baseline.
Whether the UE can only report the INACTIVE/IDLE QoE reports to gNB when the UE has entered to the RRC_CONNECTED due to other reasons is pending to RAN2 discussion.
RAN3 discusses the alignment between logged Minimization of Drive Testing (MDT) and MBS QoE when basic solution for MBS QoE has been defined first.
RAN3 continues to discuss how to handle the QoE reports sent at new gNB when UE was in RRC IDLE.
No enhancements on paging for the purpose of configuring UE with legacy QoE measurement for the RRC_IDLE/INACTIVE UEs.
Legacy paging only for legacy QoE purpose is up to implementation.
Use the same set of parameters in QMC configuration for all RRC states.
RAN3 assumes that there is no need to request QoE measurements per UE RRC state.
WA: MBS service area can be expressed by QoE area scope information element (IE), For future study (FFS) on whether any enhancements of this IE are needed.
The RRC state info when UE collects the uploaded QoE data shall not be reported in QoE report for MBS BC. MBS MC can be discussed later.
MBS BC QoE measurements can proceed after the UE switches from RRC_IDLE/RRC_INACTIVE to RRC_CONNECTED.
RAN3 to discuss which configuration information related to QoE measurement needs to be available in the new gNB.
At least the following QoE configuration related information for MBS broadcast service should be available in the new gNB:
   QoE reference
   Measurement Collection Entity Information, the detail information can be further discussed
RAN3 shall discuss which of the other QoE configuration info for MBS BC QoE shall be available in the new gNB.
   Measurement Configuration Application Layer ID (RRC level ID)
   Service Type
   Container for Application Layer Measurement Configuration (config container)
   MDT Alignment Information
   Area Scope of QMC (area scope)
   Single Network Slice Assistance Information (S-NSSAI) Information (slicing info)
   RAN Visible QoE (RVQoE) Information
   QoE measurement type (signalling based, management based)
FFS whether to support RVQoE measurements in RRC_IDLE and RRC INACTIVE
FFS whether new gNB can re-configure MBS BC QoE

### SUMMARY

Systems and methods for enabling a Public Land Mobile Network (PLMN) check for Quality of Experience (QoE) measurement reporting during User Equipment (UE) mobility are disclosed. In one embodiment, a method performed by a UE comprises receiving, from a first network node, a QE measurement configuration comprising one or more PLMN lists that indicate one or more allowed PLMNs. The method further comprises starting an application session that is subject to the QoE measurement configuration and starting QoE measurements in accordance with the QoE measurement configuration. The method further comprises transitioning from connected state to idle state. The method further comprises, in the process of transitioning from idle state to connected state with respect to a second network node, obtaining an PLMN Identifier (ID) of the second network node and determining, based on a comparison of the PLMN ID of the second network node and PLMN IDs comprised in the one or more PLMN lists, whether the UE is to send, to the second network node, any one or more of the following: a QoE report, a QoE report availability indication, a network's instance of the QoE measurement configuration stored by the UE, or an indication of availability of the network's instance of the QoE measurement configuration stored by the UE. The method further comprises operating in accordance with a result of the determining. In this manner, the UE only sends QoE reports and/or network's instance of a QoE configuration to the second network node if the second node should receive this information. This prevents this information from being sent to network nodes which should not receive it, which increases security.

In one embodiment, the one or more PLMN lists consist of a PLMN list in an area scope of the QoE measurement configuration. In one embodiment, the PLMN ID of the second network node is not in the PLMN list, and the determining comprises determining that the UE is not to send a QoE report availability indication to the second network node based on the PLMN ID of the second network node not being in the PLMN list. In another embodiment, the PLMN ID of the second network node is in the PLMN list such that the UE, and the determining comprises determining that the UE) is to send a QoE report availability indication to the second network node based on the PLMN ID of the second network node being in the PLMN list. In another embodiment, the PLMN ID of the second network node is in the PLMN list such that the UE, and the determining comprises determining that the UE is to send a QoE report to the second network node based on the PLMN ID of the second network node being in the PLMN list.

In one embodiment, the first network node is in a first PLMN, and the second network node is in a second PLMN that is different than the first PLMN. In one embodiment, the PLMN ID of the second network node is not in the PLMN list such that the UE, and the determining comprises determining that the UE is not to send a QoE report to the second network node. In another embodiment, the PLMN ID of the second network node is in the PLMN list, and the determining comprises determining that the UE is to send a QoE report availability indication to the second network node based on the PLMN ID of the second network node being in the PLMN list. In another embodiment, the PLMN ID of the second network node is in the PLMN list, and the determining comprises determining that the UE is to send a QoE report to the second network node based on the PLMN ID of the second network node not being in the PLMN list.

In one embodiment, determining comprises determining, based on the comparison of the PLMN ID of the second network node and the PLMN IDs comprised in the one or more PLMN lists, that the PLMN of the second network node is an allowed PLMN, and operating in accordance with the result of the determining comprises sending, to the second network node, any one or more of the following: a QoE report for QoE measurements performed according to the QoE measurement configuration, a QoE report availability indication for a QoE report for QoE measurements performed according to the QoE measurement configuration, the network's instance of the QoE measurement configuration stored by the UE; or an indication of availability of the network's instance of the QoE measurement configuration stored by the UE.

In one embodiment, determining comprises determining, based on the comparison of the PLMN ID of the second network node and the PLMN IDs comprised in the one or more PLMN lists, that the PLMN of the second network node is a PLMN in which the UE is allowed to perform QoE measurements in accordance with the QoE measurement configuration, and operating in accordance with the result of the determining comprises sending, to the second network node, the network's instance of the QoE measurement configuration stored by the UE or an indication of availability of the network's instance of the QoE measurement stored by the UE.

In one embodiment, determining comprises determining, based on the comparison of the PLMN ID of the second network node and the PLMN IDs comprised in the one or more PLMN lists, that the PLMN of the second network node is a PLMN in which the UE is allowed to perform QoE measurements in accordance with the QoE measurement configuration but is not a PLMN to which the UE is allowed to send QoE reports for QoE measurements performed in accordance with the QoE measurement configuration, and operating in accordance with the result of the determining comprises performing QoE measurements in accordance with the QoE measurement configuration while in the connected state with respect to the second network node but refraining from sending, to the second network node, a QoE report availability indication.

In one embodiment, determining comprises determining, based on the comparison of the PLMN ID of the second network node and the PLMN IDs comprised in the one or more PLMN lists, that the PLMN of the second network node is a PLMN in which the UE is not allowed to perform QoE measurements in accordance with the QoE measurement configuration, and operating in accordance with the result of the determining comprises ceasing to perform QoE measurements in accordance with the QoE measurement configuration.

In one embodiment, the one or more allowed PLMNs are: one or more PLMNs in which the UE is to execute QoE measurements in accordance with the QoE measurement configuration and/or one or more PLMNs to which the UE is permitted to send QoE reports and/or a stored network's instance of the QoE measurement configuration.

In one embodiment, the one or more PLMN lists comprise a single list of PLMNs in which the UE is allowed to execute QoE measurements in accordance with the QoE measurement configuration and is allowed to send associated QoE reports.

In one embodiment, the one or more PLMN lists comprise a first PLMN list containing PLMN IDs of PLMNs in which the UE is allowed to execute QoE measurements in accordance with the QoE measurement configuration and a second PLMN list containing PLMN IDs of PLMNs to which the UE is allowed to send associated QoE reports.

In one embodiment, the one or more PLMN lists comprise a first PLMN list containing PLMN IDs of PLMNs in which the UE is allowed to execute QoE measurements in accordance with the QoE measurement configuration and a second PLMN list containing PLMN IDs of PLMNs to which the UE is allowed to send associated QoE reports and the stored network's instance of the QoE measurement configuration.

In one embodiment, the one or more PLMN lists comprise a first PLMN list containing PLMN IDs of PLMNs in which the UE is allowed to execute QoE measurements in accordance with the QoE measurement configuration, a second PLMN list containing PLMN IDs of PLMNs to which the UE is allowed to send associated QoE reports, a third PLMN list containing PLMN IDs of PLMNs to which the UE is allowed to send the stored network's instance of the QoE measurement configuration.

In one embodiment, the one or more PLMN lists comprise a first PLMN list containing PLMN IDs of PLMNs in which the UE is allowed to send associated QoE reports and a second PLMN list containing PLMN IDs of PLMNs to which the UE is allowed to send the stored network's instance of the QoE measurement configuration.

In one embodiment, the one or more PLMN lists comprise a PLMN list containing PLMN IDs of PLMNs in which the UE is allowed to send associated QoE reports.

In one embodiment, the one or more PLMN lists comprise a PLMN list containing PLMN IDs of PLMNs in which the UE is allowed only to send associated QoE reports.

In one embodiment, the one or more PLMN lists comprise a PLMN list containing PLMN IDs of PLMNs in which the UE is allowed to execute QoE measurements in accordance with the QoE measurement configuration but not allowed to send associated QoE reports.

In one embodiment, the one or more PLMN lists comprise a PLMN list containing PLMN IDs of PLMNs in which the UE is allowed to send the stored network's instance of the QoE measurement configuration.

In one embodiment, the one or more PLMN lists comprise a PLMN list containing PLMN IDs of PLMNs in which the UE is allowed to only send the stored network's instance of the QoE measurement configuration.

Corresponding embodiments of a UE are also disclosed. In one embodiment, a UE is adapted to receive, from a first network node, a QoE measurement configuration comprising one or more PLMN lists that indicate one or more allowed PLMNs. The UE is further adapted to start an application session that is subject to the QoE measurement configuration, start QoE measurements in accordance with the QoE measurement configuration, and transition from connected state to idle state. The UE is further adapted to, in the process of transitioning from idle state to connected state with respect to a second network node, obtain an PLMN ID of the second network node an determine, based on a comparison of the PLMN ID of the second network node and PLMN IDs comprised in the one or more PLMN lists, whether the UE is to send, to the second network node, any one or more of the following: a QoE report, a QoE report availability indication, a network's instance of the QoE measurement configuration stored by the UE, or an indication of availability of the network's instance of the QoE measurement configuration stored by the UE. The UE is further adapted to operate in accordance with a result of the determining.

Embodiments of a method performed by a first network node are also disclosed. In one embodiment, a method performed by a first network node comprises sending, to a UE, a QoE measurement configuration comprising one or more PLMN lists that indicate one or more allowed PLMNs and causing the UE to transition from connected state to idle state.

In one embodiment, the one or more allowed PLMNs are one or more PLMNs in which the UE is to execute QoE measurements in accordance with the QoE measurement configuration and/or one or more PLMNs to which the UE is permitted to send QoE reports and/or a stored network's instance of the QoE measurement configuration.

Corresponding embodiments of a first network node are also disclosed. In one embodiment, a first network node is adapted to send, to a UE, a QoE measurement configuration comprising one or more PLMN lists that indicate one or more allowed PLMNs and cause the UE to transition from connected state to idle state.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates the operation of a User Equipment (UE), an old gNodeB (gNB), and a new gNB, in accordance with an embodiment of the present disclosure;

FIG. 2 shows an example of a communication system in accordance with some embodiments;

FIG. 3 shows a UE in accordance with some embodiments;

FIG. 4 shows a network node in accordance with some embodiments;

FIG. 5 is a block diagram of a host, which may be an embodiment of the host of FIG. 2, in accordance with various aspects described herein;

FIG. 6 is a block diagram illustrating a virtualization environment in which functions implemented by some embodiments may be virtualized; and

FIG. 7 shows a communication diagram of a host communicating via a network node with a UE over a partially wireless connection in accordance with some embodiments.

### DETAILED DESCRIPTION

The embodiments set forth below represent information to enable those skilled in the art to practice the embodiments and illustrate the best mode of practicing the embodiments.

Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenge(s) in regard to Quality of Experience (QoE) measurements in a 3rd Generation Partnership Project (3GPP) system (e.g., a 5th Generation (5G) system). The RAN3 working group in 3GPP is currently discussing the support for QoE measurements for Multicast/Broadcast Services (MBS) when the User Equipment (UE) is in Radio Resource Control (RRC) IDLE or INACTIVE state. If a UE is configured to perform QoE measurements in IDLE state, 3GPP agreed that the UE will retain the QoE measurement configuration during the measurement execution. On the other hand, one problem that 3GPP is addressing is that, when the UE transitions to RRC_IDLE, according to current specifications, the gNodeB (gNB) that served the UE prior to transition to IDLE state shall delete the UE context (i.e., the information associated with the UE). That means that the gNB deletes all the information it has about the QoE measurement configurations of the UE. Then, when the UE comes back from IDLE to CONNECTED state, the UE may connect to another gNB, which, will have no information about the UE's QoE measurement configurations.

To overcome this issue, 3GPP agreed that, upon UE's transition to IDLE, the network's instance of the QoE measurement configuration for the UE will not be deleted, but, instead, stored somewhere other than in the gNB. The discussion about where to store the network's instance of the UE's QoE measurement configuration is ongoing. The ground principle in the discussion is that the stored information provided to the new gNB will ensure continuity of an ongoing QoE measurement for MBS service even if the UE transits between RRC states during the application session (i.e., during the measurement). Restoration of the network's instance of the QoE measurement configuration for the UE will also serve to enable the gNB to forward QoE measurement results received from the UE to the correct Measurement Collector Entity (MCE).

In some scenarios, the UE may return from IDLE to CONNECTED state by connecting to a gNB in a different Public Land Mobile Network (PLMN) than the one the UE was in when it entered the IDLE state and/or when it received the QoE configuration (these PLMNs are referred to herein as the “new PLMN” and “old PLMN,” respectively). The essential properties of this scenario are:
The new PLMN may be a non-equivalent PLMN.
Upon connecting to the new gNB, if the UE has stored QoE reports collected while in IDLE, the UE can send “QoE report availability” indication to the new gNB.
If the PLMN of the new gNB (i.e., the new PLMN) is a non-equivalent PLMN, the UE should not send the “QoE report availability” indication to the new gNB, one reason being that the MCE to which the QoE reports should be forwarded by the gNB may not be a part of, or may not be reachable from, the new PLMN.
When a UE is not configured for QoE measurements, it does not receive the information about the area scope, meaning that it does not know in which PLMNs it is allowed to execute QoE measurements and send the reports.
In case 3GPP decides that the network's instance of QoE configuration is to be stored at the UE while the UE is in IDLE, the UE should send the stored information to the new gNB, to ensure QoE measurement and reporting continuity, but only if this gNB is inside an equivalent PLMN.
If the new PLMN is a non-legitimate receiver of the stored network's instance of the QoE configuration, as well as any stored QoE reports (containing measurement results collected in the old PLMN) (depending e.g. on the business relation between the operators of the new and the old PLMN), then unwanted leakage of information between PLMNs will be the result if the UE sends this information to the new PLMN, wherein the leaked information sometimes may be regarded as sensitive. Whether a certain PLMN is a legitimate receiver of the concerned information is determined by the operator of the old PLMN. One possibility is that the equivalent PLMNs constitute the legitimate receivers of the information.

As of today, it is unclear how to ensure that the stored QoE reports and the stored network's instance of QoE configuration for the UE are only provided by the UE to a gNB in an equivalent PLMN.

Certain aspects of the disclosure and their embodiments may provide solutions to these or other challenges. Systems and methods are disclosed herein for a UE returning from IDLE to CONNECTED state to determine whether the UE should deliver stored QoE reports and a stored network's instance of QoE configuration information to the gNB that serves the UE upon its return to CONNECTED state.

According to one embodiment, a Radio Access Network (RAN) node can also provide instructions to a UE in RRC_CONNECTED, or upon releasing the UE from RRC_CONNECTED to a non-connected RRC state. The instructions concern whether the UE is allowed or not allowed to deliver stored QoE/RAN Visible QoE (RVQoE) reports to a new gNB (e.g., when the UE transitions back to CONNECTED state) based on the PLMN towards which the mobility is performed. Note that legacy QoE measurement reports are provided in an encapsulated format, whereas RVQoE measurement reports are visible to the RAN (e.g., encoded in RRC format), as understood by those of ordinary skill in the art.

Certain embodiments may provide one or more of the following technical advantage(s). An advantage of embodiments of the solution described herein is that the UE only sends QoE reports or network's instance of a QoE configuration to a gNB which is intended to receive it. This prevents the information to be sent to gNBs which should not receive it, which increases security.

As used herein, a “network node” can be a RAN node, a gNodeB (gNB), eNodeB (eNB), en-gNB, next generation eNB (ng-eNB), gNB-Central Unit (CU), gNB-Distributed Unit (DU), gNB-CU-Control Plane (CP), gNB-CU-User Plane (UP), eNB-CU, eNB-CU-CP, eNB-CU-UP, Integrated Access and Backhaul (IAB)-node, IAB-donor DU, IAB-donor-CU, IAB-DU, IAB-Mobile Termination (MT), Open RAN (O)-CU, O-CU-CP, O-CU-UP, O-DU, O-Radio Unit (RU), O-eNB, a Non-Real Time RAN Intelligent Controller (Non-RT RIC), a Real-Time RAN Intelligent Controller (RT-RIC), or the like.

The terms “application layer measurement configuration”, “application measurement configuration”, “QoE measurement configuration”, “QoE configuration”, “QoE measurement and reporting configuration” and “QMC configuration” are used interchangeably. But note that the “QMC configuration file” is not an equivalent term, but instead refers to the part of the QoE configuration consisting of an XML file containing instructions of QoE metrics to be collected etc.

The terms “QoE report” and “QoE measurement report” are used interchangeably.

The terms “QoE configuration” and “QoE measurement configuration” are used interchangeably.

The term “network's instance of QoE configuration” refers to the information that the gNB when serving the UE in RRC_CONNECTED, the information referring to those QoE measurement configurations that are eligible to be executed in RRC_IDLE mode. According to the 3GPP agreements, the network's instance of QoE configuration is to be stored while the UE is in RRC IDLE mode.

The terms “access stratum”, “UE AS” and “radio layer” are used interchangeably when referring to a UE.

The solution proposed in the present disclosure applies to New Radio (NR) as well as future Radio Access Technologies (RATs) such as 6^{th} Generation (6G), with the IAB-MT a parent backhaul link terminating function and the IAB-DU an access service providing function of a relay node.

“Sending reports to a node” may or may not mean that the said node is the consumer, i.e., the end destination of the reports.

The terms “node”, “network node”, “gNB” and “RAN node” are used interchangeably herein.

The terms “session” and “application session” are used interchangeably.

The solution is described herein using an example of QoE measurements for MBS, but is equally applicable to QoE measurements for any service type that can be collected in IDLE state.

The solution is described herein using an example where the session is ongoing while the UE transits from RRC CONNECTED to RRC IDLE and back to RRC_CONNECTED, but it applies even if the measurements have started while the UE was in RRC IDLE.

In the solution description, it is sometimes mentioned that the UE is not allowed to send QoE reports in a certain PLMN, e.g., a new PLMN. This also means that the UE is not allowed to indicate availability of stored QoE report(s) in that PLMN. Conversely, if the UE is allowed to send QoE reports in a certain PLMN, this means that the UE is also allowed to indicate availability of QoE report(s) in that PLMN.

In the solution description, it is often described that a PLMN or a list of PLMNs is sent to the UE, or that a PLMN is indicated. In such expressions, “PLMN” refers to a PLMN ID, which consists of a MCC and an MNC.

“Sending a report/configuration to a PLMN” means sending this information to a gNB whose cell serving the UE is in that PLMN.

Sending, from a UE, a network's instance of a QoE configuration (which the UE has stored on behalf of the network while the UE was in RRC_IDLE state) may include a prior indication (from the UE to the network) of availability of such a network's instance of a QoE configuration at the UE. Upon reception of such an indication, the network may or may not choose to request the UE to send the network's instance of the QoE configuration. If this is how the sending of the network's instance of the QoE configuration is performed, then, if the UE is not allowed to send a network's instance of a QoE configuration in a certain PLMN, e.g., a new PLMN, this also means that the UE is not allowed to indicate availability of a stored such network's instance of a QoE configuration. Conversely, if the UE is allowed to send the network's instance of the QoE configuration in a certain PLMN, this means that the UE is also allowed to indicate availability of the network's instance of the QoE configuration to the network in that PLMN. Note also that it is possible that the sending of the network's instance of a QoE configuration to the network only involves sending of the network's instance of the QoE configuration without a prior indication of availability of this network's instance of the QoE configuration.

In this description, the following terms are regarded as equivalent: RRC_IDLE, IDLE, RRC_IDLE state, IDLE state, RRC_IDLE mode, IDLE mode, idle state, idle mode. Furthermore, the following terms are regarded as equivalent: RRC_INACTIVE, INACTIVE, RRC INACTIVE state, INACTIVE state, RRC_ INACTIVE mode, INACTIVE mode, inactive state, inactive mode. Similarly, the following terms are regarded as equivalent: RRC_CONNECTED, CONNECTED, RRC_CONNECTED state, CONNECTED state, RRC_CONNECTED mode, CONNECTED mode, connected state, connected mode.

The general scenario involves a UE that transits to RRC CONNECTED state after spending some time in the IDLE state during which it has been executing QoE measurements and storing the reports. Further details of the scenario are:
The application session and QoE measurement are ongoing as the UE transitions from RRC CONNECTED to RRC IDLE and back to RRC_CONNECTED. Alternatively, the application session and the QoE measurements start while the UE is in RRC IDLE state.
The gNB that the UE connects to upon return to RRC_CONNECTED state is different than the node serving the UE upon its previous transition from RRC CONNECTED to RRC IDLE state. The former is referred to as the new gNB, and the latter is referred to as the old gNB.
According to current agreements, if the UE has stored QoE reports collected while in IDLE state, the UE will send a “QoE report availability” indication to the new gNB.
In case 3GPP decides that the network's instance of QoE configuration is to be stored at the UE while the UE is in RRC_IDLE, the UE should send the stored information to the new gNB, to ensure QoE measurement and reporting continuity, but only if this gNB is inside an equivalent PLMN or if the gNB is identified by a specific network identifier.

The solution is described using the example of one QoE measurement configuration but is equally applicable to any number of QoE measurement configurations at the UE.

Another scenario involves a UE which is handed over (i.e., in RRC_CONNECTED state) to a PLMN which is an equivalent PLMN but not included in the Area Scope for QoE/RVQoE measurements. For instance, the source RAN node, as part of the QoE/RVQoE configuration sent to the UE, includes a first “Mobility to Equivalent PLMN” parameter, which will make the UE understand that in case of mobility towards an Equivalent PLMN not included in the Area Scope, the UE should treat the QoE/RVQoE measurements and/or QoE/RVQoE reporting in the same way as described in the solution for UE transitioning from RRC_CONNECTED to RRC_IDLE. In a variant of this, the “Mobility to Equivalent PLMN” parameter will let the UE know that in case of mobility towards any Equivalent PLMN, the UE should treat the QoE/RVQoE measurements and/or QoE/RVQoE reporting in the same way as described in the solution for UE transitioning from RRC_CONNECTED to RRC_IDLE.

In one variant, the source RAN node—as part of the handover execution, for instance within the RRCReconfiguration message containing the Handover Command prepared by the target RAN node—sends to the UE a second “Mobility to Equivalent PLMN” parameter (which in one variant is the same as the first “Mobility to Equivalent PLMN” parameter described above). The second “Mobility to Equivalent PLMN” parameter will make the UE understand that, once the UE will be served by/connected to the target RAN node, it will have to treat the QoE/RVQoE measurements and/or QoE/RVQoE reporting in the same way as described in the solution for UE transitioning from RRC_CONNECTED to RRC IDLE.

In another variant, in case of transition from RRC CONNECTED to RRC_IDLE or to RRC_INACTIVE, the RAN node instructs the UE (e.g., in the RRCRelease message) that, when reconnecting or resuming towards a cell which belongs to an Equivalent PLMN not included in the Area Scope, the UE should apply the methods described in the disclosure. The instruction can be sent using a third “Mobility to Equivalent PLMN” parameter, which can be the same as the first and/or second “Mobility to Equivalent PLMN” parameter(s) described above, or a different one.

The terms “new PLMN” and “old PLMN” are used herein. As long as only two PLMNs are involved, these terms are quite clear. However, in some scenarios/embodiments, a UE may receive the QoE configuration in a first PLMN (PLMN1), then move to a second PLMN (PLMN2), and then move to a third PLMN (PLMN3). In such a scenario/embodiment, the first PLMN (PLMN1) is regarded as the “old PLMN”, even when the UE has entered/connected the third PLMN (PLMN3), i.e. it is the PLMN from which the UE received the QoE configuration that is the “old PLMN”. Note also that the term “old gNB” refers to a gNB in the old PLMN. Similarly, the term “new gNB” refers to a gNB in the new PLMN.

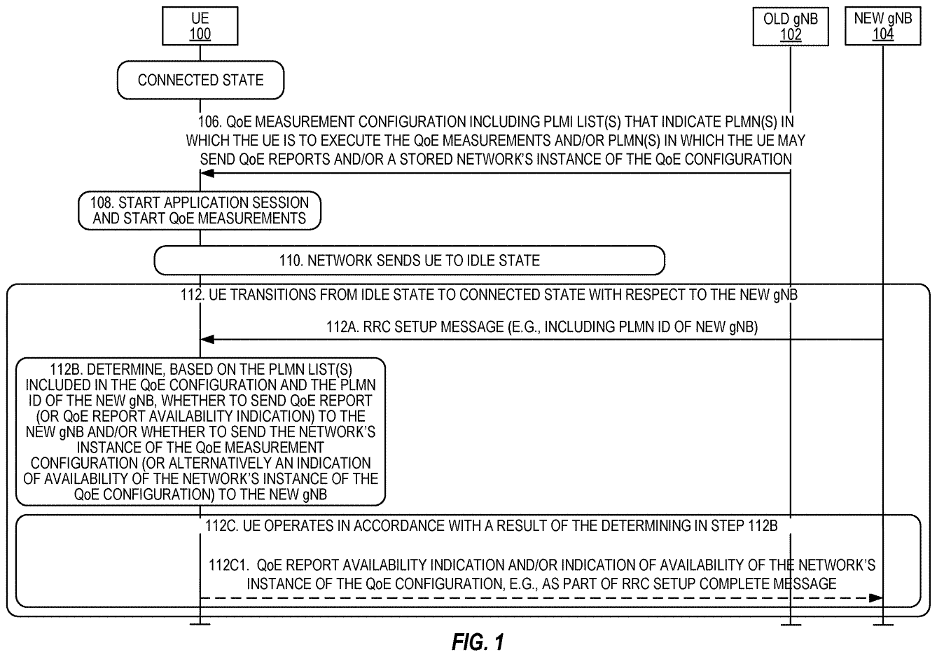

FIG. 1 illustrates the operation of a UE 100, an old gNB 102, and a new gNB 104 in accordance with one embodiment of the present disclosure. Optional steps are represented by dashed lines/boxes. Further, while the steps are illustrated in FIG. 1 in a particular order, the steps may be performed in any suitable order. The steps of the procedure are as follows:

### Step 106:

The UE 100, while in RRC_CONNECTED state, receives from the old gNB 102 a QoE measurement configuration (e.g., for MBS service), according to which the UE 100 is to execute QoE measurements in RRC_CONNECTED, RRC_INACTIVE, and RRC IDLE states. As a part of the measurement configuration, the UE 100 receives a list of PLMNs in which it should execute measurements and/or to which it may send QoE reports and/or a stored network's instance of the QoE configuration. These PLMNs are herein referred to as the “equivalent PLMNs” or “allowed PLMNs.” (Note: a list of PLMNs in which the UE should execute measurements is referred to as the PLMN target in TS 28.405, v18.2.0)
In one variant, the UE receives one list of equivalent PLMNs in which it is allowed to execute QoE measurements and is allowed to send the reports to these PLMNs.
In another variant, the UE receives two lists of PLMNs. The first list contains PLMNs in which the UE is allowed to execute measurements, and the second list contains the PLMNs to which it is allowed to send the reports.
In another variant, the UE receives two lists of PLMNs. The first list contains PLMNs in which the UE is allowed to execute measurements, and the second list contains the PLMNs to which it is allowed to send the reports and the stored network's instance of the QoE configuration.
In another variant, the UE receives three lists of PLMNs. The first list contains PLMNs in which the UE is allowed to execute measurements, the second list contains the PLMNs to which it is allowed to send the reports, and the third list contains the PLMNs to which it is allowed to send the stored network's instance of the QoE configuration.
In another variant, the UE receives two lists of PLMNs. The first list contains PLMNs to which the UE is allowed to send the reports and the second list contains the PLMNs to which the UE is allowed to send the stored network's instance of the QoE configuration.
In one variant, the UE receives one PLMN list, containing the PLMNs in which the UE is allowed only to send the reports.
In one variant, the UE receives one PLMN list, containing the PLMNs in which the UE is allowed only to measure, but not to send the reports (i.e., it needs to store the reports).
In one variant, the UE receives one PLMN list, containing the PLMNs in which the UE is allowed only to send the stored network's instance of the QoE configuration.
In one variant, the list(s) are identical to the PLMN list in the area scope (e.g., in the Area Scope for QMC IE in TS 38.413v17.4.0) that the RAN node receives from the OAM. In another variant, the “reporting list” is a subset of the PLMN list in the area scope.
In one variant, the UE receives a list of equivalent PLMNs not included in the Area Scope for QMC IE in TS 38.413v17.4.0, where it is allowed to continue to execute measurements, but not to send the reports.
In one variant, the UE receives a list of equivalent PLMNs not included in the Area Scope for QMC IE in TS 38.413v17.4.0, where it is not allowed to continue to execute measurements, and it is not allowed to send the reports.
In one variant, the UE receives an indication to continue executing measurements when it moves to any equivalent PLMN
In one variant, the UE receives an indication to not report any QoE/RVQUE measurements when moving to any non-equivalent PLMN
In one variant, the UE is instructed to not report any QoE configuration information received by the RAN at any time (or as alternative, any QoE configuration information received by the RAN when it was released to RRC_IDLE) towards any equivalent PLMN.
In one variant, the UE is instructed to not report any QoE configuration information received by the RAN at any time (or as alternative, any QoE configuration information received by the RAN when it was released to RRC_IDLE) towards any non-equivalent PLMN
In one variant, the UE is instructed to not report any QoE configuration information received by the RAN at any time (or as alternative, any QoE configuration information received by the RAN when it was released to RRC_IDLE) towards any equivalent PLMN that is not in the list of Equivalent-PLMNs included in the Area Scope.
In one variant, the UE receives from the network the network's instance of QoE measurement configuration, to be stored while the UE is in RRC IDLE mode. This can alternatively be done in Step 2 or 3.
In one variant, the UE receives a PLMN list, containing the PLMNs in which the UE is allowed to send the network's instance of QoE measurement configuration after the UE returns to RRC CONNECTED. This list may be the same list as any of the above lists, or a separate list.
In one variant, for each entry in the list of PLMNs to which the reports may be sent, the network also indicates a separate identifier of the MCE to which the gNB should forward the reports, e.g., the MCE ID or an MCE Uniform Resource Indicator (URI) or the MCE IP address.
In one variant, the receives the PLMN list(s) as a part of, or together with, the network's instance of QoE measurement configuration.
In one variant, instead of receiving a PLMN list, the UE receives a network or gNB identifier, identifying the network or gNB to which the UE is allowed to send the network's instance of the QoE configuration and/or the QoE reports. The network identifier can, e.g., be used to identify a certain operator or a certain network vendor.

### Step 108:

The UE starts the application session subject to above measurement configuration and starts QoE measurements. This can occur while the UE is in RRC_CONNECTED, RRC_INACTIVE or RRC_IDLE state. Furthermore, it may occur before or after the UE has moved to the new PLMN. It is also possible that the UE moves to, and transits to RRC_CONNECTED state in the new PLMN, and then transits back to RRC_INACTIVE or RRC_IDLE state in the new PLMN, and then starts the application session subject to the above measurement configuration and starts the QoE measurements, and then returns to RRC_CONNECTED state again in the new PLMN.

This step is optional. However, if it is not performed, this means that there will be no stored QoE measurement reports to send (or not to send) in the new PLMN.

### Step 110:

The network sends the UE to RRC_IDLE state (this step may in some cases be performed before step 2). The application session and QoE measurement may be ongoing when the UE is released to RRC_IDLE state, but the application session and the QoE measurement session may be started after the transition to RRC_IDLE state too (see also step 2). The UE stores the assembled QoE reports.
In one variant, just before being sent by the network to RRC_IDLE state, the UE receives from the network the network's instance of the QoE measurement configuration, to be stored while the UE is in RRC_IDLE mode. This can alternatively be done in Step 1 or 2.

### Step 112:

In the process of transition from RRC_IDLE to RRC_CONNECTED state, the UE receives the RRCSetup message from the new gNB (step 112A). The UE checks the PLMN list(s) that it previously received from the old gNB, and based on the list content and the PLMN of new gNB, the UE decides (step 112B) whether it should send to the network one or both or none of the following:
The “QoE report availability” indication.
The network's instance of the QoE measurement configuration.
Alternatively, an indication of availability of the network's instance of the QoE measurement configuration.

The UE operates in accordance with a result of the decision in step 112C.

More specifically, in one embodiment, if the PLMN of the new gNB is in the list of PLMNs to which the UE is allowed to send the QoE reports (also including the case of one integral list for both QoE reporting and QoE configuration delivery), the UE sends the “QoE report availability” indication, e.g. as a part of the RRCSetupComplete message (step 112C1).

Subsequently, the UE sends the stored reports to the network (e.g., after SRB4 has been established), possibly upon request from the network.
If the UE received a dedicated ID (or URI or URL or IP address) of the MCE to which the reports in this PLMN should be sent, the UE indicates the MCE ID to the gNB, and the gNB forwards the reports to this MCE.
In one variant, the UE will send to the new gNB only the reports that were collected in IDLE state while the UE was in that same PLMN. In another variant, all stored reports will be sent.
In one variant, the UE is instructed in which order to send the reports, e.g. send newest reports first or send oldest reports first.

If the PLMN of the new gNB is in the list of PLMNs in which the UE is allowed to execute QoE measurements (also including the case of one integral list for both QoE reporting and QoE configuration delivery) or if the gNB is a gNB to which to UE is allowed to send the QoE reports or the network's instance of the QoE measurement configuration according to a network or gNB identifier, the UE sends the stored network's instance of QoE measurement configuration as a part of the RRCSetupComplete message, or another RRC_message.

If the PLMN of the new gNB is in the list of PLMN(s) in which the UE can execute QoE measurements, and not in the list of PLMNs to which the UE is allowed to send the QoE reports, the UE will continue to execute measurements and store the reports, without sending them to the network and without indicating their availability to the network.

If the PLMN of the new gNB is in the list of PLMNs in which the UE is allowed to send the network's instance of the QoE configuration, the UE either sends the network's instance of the QoE measurement configuration to the network or sends an indication of availability of the network's instance of the QoE measurement configuration.

If the PLMN of the new gNB is not in the list of PLMNs in which the UE is allowed to execute QoE measurements, the UE will stop performing the QoE measurements. If the UE is not allowed to send QoE reports or the network's instance of the QoE configuration either, the UE will not indicate the presence of any QoE reports or QoE configuration in an RRC message to the network.

### Additional Embodiments and Variations

For any of the above-mentioned lists of PLMNs, the list of PLMNs may be a list that is stored in the Universal Subscriber Identity Module (USIM) (e.g., entered into the USIM prior to, or at the time of, provision of the subscription (e.g. a subscription associated with UE or the user of the UE)) instead of a list of PLMNs sent to the UE in the old PLMN. An example of such a list stored in the USIM is the list of Equivalent Home PLMNs.

In some embodiments, the UE performs QoE measurements (continued or newly started) in the new PLMN in accordance with the QoE configuration received in the old PLMN (wherein the QoE measurements may be performed in any RRC_state, in particular in RRC_IDLE state). In some embodiments, the UE is allowed to send a QoE report in the new PLMN if the QoE report at least partly contains information collected in the new PLMN. In other embodiments, the UE is allowed to send a QoE report in the new PLMN only if the QoE report only contains information collected in the new PLMN. As an option, the UE may prune a compiled QoE report from information that was not collected in the new PLMN (i.e., remove such information from the QoE report), so that the QoE report fulfills the requirement to only contain information collected in the new PLMN so that the UE is allowed to send the QoE report in the new PLMN. In all these embodiments, the rule and/or behavior the UE follows may be configured by the old PLMN or may be specified in a standard.

### UE Capability Signaling

For the proposed solution to be executed, in one embodiment, the UE indicates to the network that it is capable of reporting according to the variants of this solution.
The UE may indicate its capability in the form of ENUMERATED indication type, e.g., “two PLMN lists supported”.
Alternatively, the capability of supporting different variants of the solution may be indicated in the form of a bitmap, where each bit corresponds to one variant. A bit value of “1” may mean that the variant is supported and value “0” may mean that it is not supported, or vice versa.

An example implementation in TS 38.331 v17.4.0 is shown below:

>>>>>>>>>>>>>Start of example implementation<<<<<<<<<<<

### 5.3.3.4 Reception of the RRCSetup by the UE

The UE shall perform the following actions upon reception of the RRCSetup:
1> set the content of RRCSetupComplete message as follows:
   [. . . ]
   2> if the UE has logged measurements available for NR and if the RPLMN is included in plmn-IdentityList stored in VarLogMeasReport:
      3> include the logMeasAvailable in the RRCSetupComplete message;
      3> if Bluetooth measurement results are included in the logged measurements the UE has available for NR:
         4> include the logMeasAvailableBT in the RRCSetupComplete message;
      3> if WLAN measurement results are included in the logged measurements the UE has available for NR:
         4> include the logMeasAvailableWLAN in the RRCSetupComplete message;
   2> if the sigLoggedMeas Type in VarLogMeasReport is included:
      3> if T 330 timer is running and the logged measurements configuration is for NR:
         4> set sigLogMeasConfigAvailable to true in the RRCSetupComplete message;
      3> else:
         4> if the UE has logged measurements available for NR:
         5> set sigLogMeasConfigAvailable to false in the RRCSetupComplete message;
   2> if the UE has QoE measurements available for NR and a stored QE measurement configuration, and if the RPLMN is included in plmn-IdentityList stored in VarLog MeasReportApplayer, or VarLogMeas ConfigAppLayer
   2> if the UE has QoE measurements available for NR and a stored QoE measurement configuration, and if the RPLMN is included in plmn-IdentityList stored as part of the corresponding QoE configuration:
      3> include the measReportAppLayerAvailable and the appLayerMeasNetworkConfigStored in the RRCSetupComplete message;
   2> if the UE has connection establishment failure or connection resume failure information available in VarConnEstFailReport or VarConnEstFailReportList and if the RPLMN is equal to plmn-Identity stored in VarConnEstFailReport or in at least one of the entries of VarConnEstFailReportList:
      3> include connEstFailInfoAvailable in the RRCSetupComplete message;
         [. . . ]
1> submit the RRCSetupComplete message to lower layers for transmission, upon which the procedure ends.
   >>>>>>>>>>>>>End of example implementation<<<<<<<<<<<

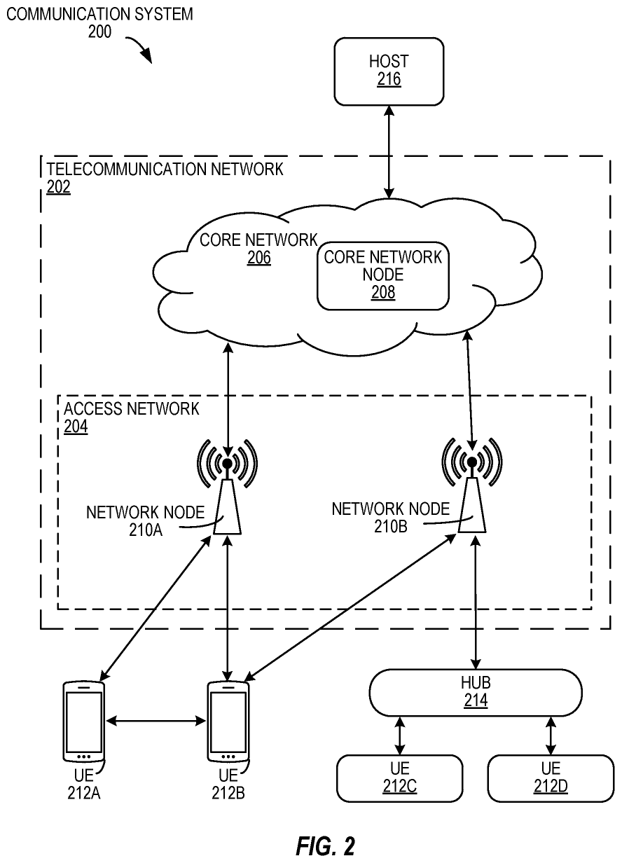

FIG. 2 shows an example of a communication system 200 in accordance with some embodiments. It should be noted, as will be understood by those of ordinary skill in the art, that the UEs and network nodes described in FIG. 2 and the following figures may operate in accordance with the description above regarding the functionality of the UE and network node/RAN node/gNB.

In the example, the communication system 200 includes a telecommunication network 202 that includes an access network 204, such as a Radio Access Network (RAN), and a core network 206, which includes one or more core network nodes 208. The access network 204 includes one or more access network nodes, such as network nodes 210A and 210B (one or more of which may be generally referred to as network nodes 210), or any other similar Third Generation Partnership Project (3GPP) access nodes or non-3GPP Access Points (APs). Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 202 includes one or more Open-RAN (ORAN) network nodes. An ORAN network node is a node in the telecommunication network 202 that supports an ORAN specification (e.g., a specification published by the O-RAN Alliance, or any similar organization) and may operate alone or together with other nodes to implement one or more functionalities of any node in the telecommunication network 202, including one or more network nodes 210 and/or core network nodes 208.

Examples of an ORAN network node include an Open Radio Unit (O-RU), an Open Distributed Unit (O-DU), an Open Central Unit (O-CU), including an O-CU Control Plane (O-CU-CP) or an O-CU User Plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 210 facilitate direct or indirect connection of User Equipment (UE), such as by connecting UEs 212A, 212B, 212C, and 212D (one or more of which may be generally referred to as UEs 212) to the core network 206 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 200 may include any number of wired or wireless networks, network nodes, UEs, and/or any other components or systems that may facilitate or participate in the communication of data and/or signals whether via wired or wireless connections. The communication system 200 may include and/or interface with any type of communication, telecommunication, data, cellular, radio network, and/or other similar type of system.

The UEs 212 may be any of a wide variety of communication devices, including wireless devices arranged, configured, and/or operable to communicate wirelessly with the network nodes 210 and other communication devices. Similarly, the network nodes 210 are arranged, capable, configured, and/or operable to communicate directly or indirectly with the UEs 212 and/or with other network nodes or equipment in the telecommunication network 202 to enable and/or provide network access, such as wireless network access, and/or to perform other functions, such as administration in the telecommunication network 202.

In the depicted example, the core network 206 connects the network nodes 210 to one or more hosts, such as host 216. These connections may be direct or indirect via one or more intermediary networks or devices. In other examples, network nodes may be directly coupled to hosts. The core network 206 includes one more core network nodes (e.g., core network node 208) that are structured with hardware and software components. Features of these components may be substantially similar to those described with respect to the UEs, network nodes, and/or hosts, such that the descriptions thereof are generally applicable to the corresponding components of the core network node 208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 216 may be under the ownership or control of a service provider other than an operator or provider of the access network 204 and/or the telecommunication network 202, and may be operated by the service provider or on behalf of the service provider. The host 216 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 200 of FIG. 2 enables connectivity between the UEs, network nodes, and hosts. In that sense, the communication system 200 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 202 is a cellular network that implements 3GPP standardized features. Accordingly, the telecommunication network 202 may support network slicing to provide different logical networks to different devices that are connected to the telecommunication network 202. For example, the telecommunication network 202 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IOT) services to yet further UEs.

In some examples, the UEs 212 are configured to transmit and/or receive information without direct human interaction. For instance, a UE may be designed to transmit information to the access network 204 on a predetermined schedule, when triggered by an internal or external event, or in response to requests from the access network 204. Additionally, a UE may be configured for operating in single-or multi-Radio Access Technology (RAT) or multi-standard mode. For example, a UE may operate with any one or combination of WiFi, New Radio (NR), and LTE, i.e. being configured for Multi-Radio Dual Connectivity (MR-DC), such as Evolved UMTS Terrestrial RAN (E-UTRAN) NR-Dual Connectivity (EN-DC).

In the example, a hub 214 communicates with the access network 204 to facilitate indirect communication between one or more UEs (e.g., UE 212C and/or 212D) and network nodes (e.g., network node 210B). In some examples, the hub 214 may be a controller, router, content source and analytics, or any of the other communication devices described herein regarding UEs. For example, the hub 214 may be a broadband router enabling access to the core network 206 for the UEs. As another example, the hub 214 may be a controller that sends commands or instructions to one or more actuators in the UEs. Commands or instructions may be received from the UEs, network nodes 210, or by executable code, script, process, or other instructions in the hub 214. As another example, the hub 214 may be a data collector that acts as temporary storage for UE data and, in some embodiments, may perform analysis or other processing of the data. As another example, the hub 214 may be a content source. For example, for a UE that is a Virtual Reality (VR) headset, display, loudspeaker or other media delivery device, the hub 214 may retrieve VR assets, video, audio, or other media or data related to sensory information via a network node, which the hub 214 then provides to the UE either directly, after performing local processing, and/or after adding additional local content. In still another example, the hub 214 acts as a proxy server or orchestrator for the UEs, in particular if one or more of the UEs are low energy IoT devices.

The hub 214 may have a constant/persistent or intermittent connection to the network node 210B. The hub 214 may also allow for a different communication scheme and/or schedule between the hub 214 and UEs (e.g., UE 212C and/or 212D), and between the hub 214 and the core network 206. In other examples, the hub 214 is connected to the core network 206 and/or one or more UEs via a wired connection. Moreover, the hub 214 may be configured to connect to a Machine-to-Machine (M2M) service provider over the access network 204 and/or to another UE over a direct connection. In some scenarios, UEs may establish a wireless connection with the network nodes 210 while still connected via the hub 214 via a wired or wireless connection. In some embodiments, the hub 214 may be a dedicated hub-that is, a hub whose primary function is to route communications to/from the UEs from/to the network node 210B. In other embodiments, the hub 214 may be a non-dedicated hub-that is, a device which is capable of operating to route communications between the UEs and the network node 210B, but which is additionally capable of operating as a communication start and/or end point for certain data channels.

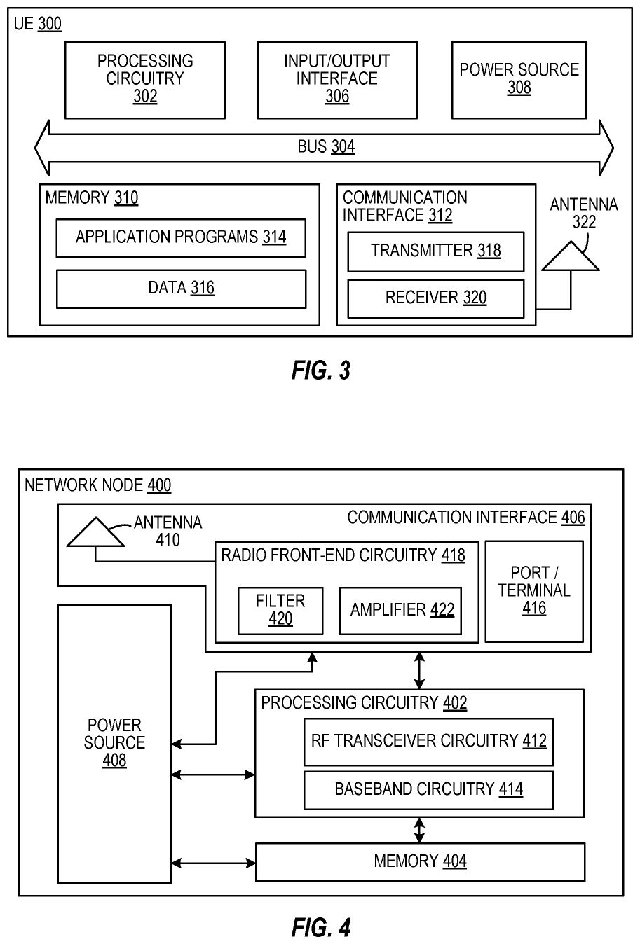

FIG. 3 shows a UE 300 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle, vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 300 includes processing circuitry 302 that is operatively coupled via a bus 304 to an input/output interface 306, a power source 308, memory 310, a communication interface 312, and/or any other component, or any combination thereof. Certain UEs may utilize all or a subset of the components shown in FIG. 3. The level of integration between the components may vary from one UE to another UE. Further, certain UEs may contain multiple instances of a component, such as multiple processors, memories, transceivers, transmitters, receivers, etc.

The processing circuitry 302 is configured to process instructions and data and may be configured to implement any sequential state machine operative to execute instructions stored as machine-readable computer programs in the memory 310. The processing circuitry 302 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 302 may include multiple Central Processing Units (CPUs).

In the example, the input/output interface 306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 300. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 308 is structured as a battery or battery pack. Other types of power sources, such as an external power source (e.g., an electricity outlet), photovoltaic device, or power cell, may be used. The power source 308 may further include power circuitry for delivering power from the power source 308 itself, and/or an external power source, to the various parts of the UE 300 via input circuitry or an interface such as an electrical power cable. Delivering power may be, for example, for charging of the power source 308. Power circuitry may perform any formatting, converting, or other modification to the power from the power source 308 to make the power suitable for the respective components of the UE 300 to which power is supplied.

The memory 310 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 310 includes one or more application programs 314, such as an operating system, web browser application, a widget, gadget engine, or other application, and corresponding data 316. The memory 310 may store, for use by the UE 300, any of a variety of various operating systems or combinations of operating systems.

The memory 310 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 310 may allow the UE 300 to access instructions, application programs, and the like stored on transitory or non-transitory memory media, to off-load data, or to upload data. An article of manufacture, such as one utilizing a communication system, may be tangibly embodied as or in the memory 310, which may be or comprise a device-readable storage medium.

The processing circuitry 302 may be configured to communicate with an access network or other network using the communication interface 312. The communication interface 312 may comprise one or more communication subsystems and may include or be communicatively coupled to an antenna 322. The communication interface 312 may include one or more transceivers used to communicate, such as by communicating with one or more remote transceivers of another device capable of wireless communication (e.g., another UE or a network node in an access network). Each transceiver may include a transmitter 318 and/or a receiver 320 appropriate to provide network communications (e.g., optical, electrical, frequency allocations, and so forth). Moreover, the transmitter 318 and receiver 320 may be coupled to one or more antennas (e.g., the antenna 322) and may share circuit components, software, or firmware, or alternatively be implemented separately.

In the illustrated embodiment, communication functions of the communication interface 312 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 312, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 300 shown in FIG. 3.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 4 shows a network node 400 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), NR Node Bs (gNBs)), and O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node), and/or Remote Radio Units (RRUs), sometimes referred to as Remote Radio Heads (RRHs). Such RRUs may or may not be integrated with an antenna as an antenna integrated radio. Parts of a distributed radio base station may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 400 includes processing circuitry 402, memory 404, a communication interface 406, and a power source 408. The network node 400 may be composed of multiple physically separate components (e.g., a NodeB component and an RNC component, or a BTS component and a BSC component, etc.), which may each have their own respective components. In certain scenarios in which the network node 400 comprises multiple separate components (e.g., BTS and BSC components), one or more of the separate components may be shared among several network nodes. For example, a single RNC may control multiple NodeBs. In such a scenario, each unique NodeB and RNC pair may in some instances be considered a single separate network node. In some embodiments, the network node 400 may be configured to support multiple RATs. In such embodiments, some components may be duplicated (e.g., separate memory 404 for different RATs) and some components may be reused (e.g., a same antenna 410 may be shared by different RATs). The network node 400 may also include multiple sets of the various illustrated components for different wireless technologies integrated into network node 400, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 400.

The processing circuitry 402 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 400 components, such as the memory 404, to provide network node 400 functionality.

In some embodiments, the processing circuitry 402 includes a System on a Chip (SOC). In some embodiments, the processing circuitry 402 includes one or more of Radio Frequency (RF) transceiver circuitry 412 and baseband processing circuitry 414. In some embodiments, the RF transceiver circuitry 412 and the baseband processing circuitry 414 may be on separate chips (or sets of chips), boards, or units, such as radio units and digital units. In alternative embodiments, part or all of the RF transceiver circuitry 412 and the baseband processing circuitry 414 may be on the same chip or set of chips, boards, or units.

The memory 404 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 402. The memory 404 may store any suitable instructions, data, or information, including a computer program, software, an application including one or more of logic, rules, code, tables, and/or other instructions capable of being executed by the processing circuitry 402 and utilized by the network node 400. The memory 404 may be used to store any calculations made by the processing circuitry 402 and/or any data received via the communication interface 406. In some embodiments, the processing circuitry 402 and the memory 404 are integrated.

The communication interface 406 is used in wired or wireless communication of signaling and/or data between a network node, access network, and/or UE. As illustrated, the communication interface 406 comprises port(s)/terminal(s) 416 to send and receive data, for example to and from a network over a wired connection. The communication interface 406 also includes radio front-end circuitry 418 that may be coupled to, or in certain embodiments a part of, the antenna 410. The radio front-end circuitry 418 comprises filters 420 and amplifiers 422. The radio front-end circuitry 418 may be connected to the antenna 410 and the processing circuitry 402. The radio front-end circuitry 418 may be configured to condition signals communicated between the antenna 410 and the processing circuitry 402. The radio front-end circuitry 418 may receive digital data that is to be sent out to other network nodes or UEs via a wireless connection. The radio front-end circuitry 418 may convert the digital data into a radio signal having the appropriate channel and bandwidth parameters using a combination of the filters 420 and/or the amplifiers 422. The radio signal may then be transmitted via the antenna 410. Similarly, when receiving data, the antenna 410 may collect radio signals which are then converted into digital data by the radio front-end circuitry 418. The digital data may be passed to the processing circuitry 402. In other embodiments, the communication interface 406 may comprise different components and/or different combinations of components.

In certain alternative embodiments, the network node 400 does not include separate radio front-end circuitry 418; instead, the processing circuitry 402 includes radio front-end circuitry and is connected to the antenna 410. Similarly, in some embodiments, all or some of the RF transceiver circuitry 412 is part of the communication interface 406. In still other embodiments, the communication interface 406 includes the one or more ports or terminals 416, the radio front-end circuitry 418, and the RF transceiver circuitry 412 as part of a radio unit (not shown), and the communication interface 406 communicates with the baseband processing circuitry 414, which is part of a digital unit (not shown).

The antenna 410 may include one or more antennas, or antenna arrays, configured to send and/or receive wireless signals. The antenna 410 may be coupled to the radio front-end circuitry 418 and may be any type of antenna capable of transmitting and receiving data and/or signals wirelessly. In certain embodiments, the antenna 410 is separate from the network node 400 and connectable to the network node 400 through an interface or port.

The antenna 410, the communication interface 406, and/or the processing circuitry 402 may be configured to perform any receiving operations and/or certain obtaining operations described herein as being performed by the network node 400. Any information, data, and/or signals may be received from a UE, another network node, and/or any other network equipment. Similarly, the antenna 410, the communication interface 406, and/or the processing circuitry 402 may be configured to perform any transmitting operations described herein as being performed by the network node 400. Any information, data, and/or signals may be transmitted to a UE, another network node, and/or any other network equipment.

The power source 408 provides power to the various components of the network node 400 in a form suitable for the respective components (e.g., at a voltage and current level needed for each respective component). The power source 408 may further comprise, or be coupled to, power management circuitry to supply the components of the network node 400 with power for performing the functionality described herein. For example, the network node 400 may be connectable to an external power source (e.g., the power grid or an electricity outlet) via input circuitry or an interface such as an electrical cable, whereby the external power source supplies power to power circuitry of the power source 408. As a further example, the power source 408 may comprise a source of power in the form of a battery or battery pack which is connected to, or integrated in, power circuitry. The battery may provide backup power should the external power source fail.

Embodiments of the network node 400 may include additional components beyond those shown in FIG. 4 for providing certain aspects of the network node's functionality, including any of the functionality described herein and/or any functionality necessary to support the subject matter described herein. For example, the network node 400 may include user interface equipment to allow input of information into the network node 400 and to allow output of information from the network node 400. This may allow a user to perform diagnostic, maintenance, repair, and other administrative functions for the network node 400.

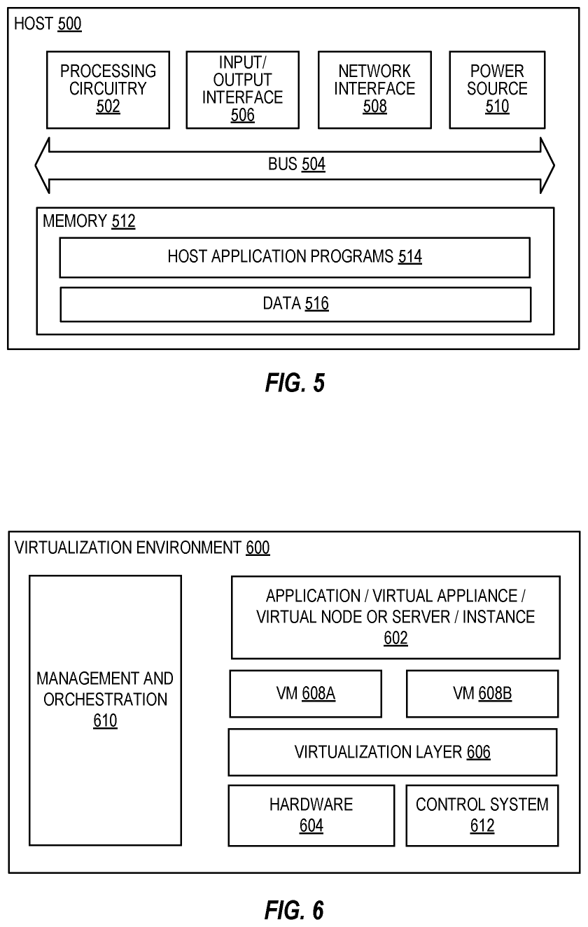

FIG. 5 is a block diagram of a host 500, which may be an embodiment of the host 216 of FIG. 2, in accordance with various aspects described herein. As used herein, the host 500 may be or comprise various combinations of hardware and/or software including a standalone server, a blade server, a cloud-implemented server, a distributed server, a virtual machine, container, or processing resources in a server farm. The host 500 may provide one or more services to one or more UEs.

The host 500 includes processing circuitry 502 that is operatively coupled via a bus 504 to an input/output interface 506, a network interface 508, a power source 510, and memory 512. Other components may be included in other embodiments. Features of these components may be substantially similar to those described with respect to the devices of previous figures, such as FIGS. 3 and 4, such that the descriptions thereof are generally applicable to the corresponding components of the host 500.

The memory 512 may include one or more computer programs including one or more host application programs 514 and data 516, which may include user data, e.g. data generated by a UE for the host 500 or data generated by the host 500 for a UE. Embodiments of the host 500 may utilize only a subset or all of the components shown. The host application programs 514 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems).

The host application programs 514 may also provide for user authentication and licensing checks and may periodically report health, routes, and content availability to a central node, such as a device in or on the edge of a core network. Accordingly, the host 500 may select and/or indicate a different host for Over-The-Top (OTT) services for a UE. The host application programs 514 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 6 is a block diagram illustrating a virtualization environment 600 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 600 includes components defined by the O-RAN Alliance, such as an O-Cloud environment orchestrated by a Service Management and Orchestration Framework via an O-2 interface.

Applications 602 (which may alternatively be called software instances, virtual appliances, network functions, virtual nodes, virtual network functions, etc.) are run in the virtualization environment 600 to implement some of the features, functions, and/or benefits of some of the embodiments disclosed herein.

Hardware 604 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 606 (also referred to as hypervisors or VM Monitors (VMMs)), provide VMs 608A and 608B (one or more of which may be generally referred to as VMs 608), and/or perform any of the functions, features, and/or benefits described in relation with some embodiments described herein. The virtualization layer 606 may present a virtual operating platform that appears like networking hardware to the VMs 608.

The VMs 608 comprise virtual processing, virtual memory, virtual networking, or interface and virtual storage, and may be run by a corresponding virtualization layer 606.

Different embodiments of the instance of a virtual appliance 602 may be implemented on one or more of the VMs 608, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 608 may be a software implementation of a physical machine that runs programs as if they were executing on a physical, non-virtualized machine. Each of the VMs 608, and that part of the hardware 604 that executes that VM, be it hardware dedicated to that VM and/or hardware shared by that VM with others of the VMs 608, forms separate virtual network elements. Still in the context of NFV, a virtual network function is responsible for handling specific network functions that run in one or more VMs 608 on top of the hardware 604 and corresponds to the application 602.

The hardware 604 may be implemented in a standalone network node with generic or specific components. The hardware 604 may implement some functions via virtualization. Alternatively, the hardware 604 may be part of a larger cluster of hardware (e.g., such as in a data center or CPE) where many hardware nodes work together and are managed via management and orchestration 610, which, among others, oversees lifecycle management of the applications 602. In some embodiments, the hardware 604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a base station. In some embodiments, some signaling can be provided with the use of a control system 612 which may alternatively be used for communication between hardware nodes and radio units.

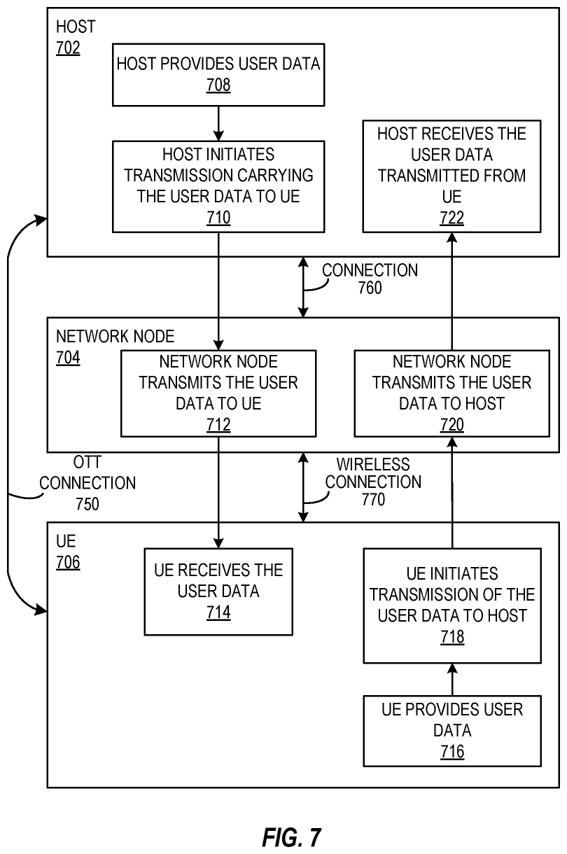

FIG. 7 shows a communication diagram of a host 702 communicating via a network node 704 with a UE 706 over a partially wireless connection in accordance with some embodiments. Example implementations, in accordance with various embodiments, of the UE (such as the UE 212A of FIG. 2 and/or the UE 300 of FIG. 3), the network node (such as the network node 210A of FIG. 2 and/or the network node 400 of FIG. 4), and the host (such as the host 216 of FIG. 2 and/or the host 500 of FIG. 5) discussed in the preceding paragraphs will now be described with reference to FIG. 7.

Like the host 500, embodiments of the host 702 include hardware, such as a communication interface, processing circuitry, and memory. The host 702 also includes software, which is stored in or is accessible by the host 702 and executable by the processing circuitry. The software includes a host application that may be operable to provide a service to a remote user, such as the UE 706 connecting via an OTT connection 750 extending between the UE 706 and the host 702. In providing the service to the remote user, a host application may provide user data which is transmitted using the OTT connection 750.

The network node 704 includes hardware enabling it to communicate with the host 702 and the UE 706. The connection 760 may be direct or pass through a core network (like the core network 206 of FIG. 2) and/or one or more other intermediate networks, such as one or more public, private, or hosted networks. For example, an intermediate network may be a backbone network or the Internet.

The UE 706 includes hardware and software, which is stored in or accessible by the UE 706 and executable by the UE's processing circuitry. The software includes a client application, such as a web browser or operator-specific “app” that may be operable to provide a service to a human or non-human user via the UE 706 with the support of the host 702. In the host 702, an executing host application may communicate with the executing client application via the OTT connection 750 terminating at the UE 706 and the host 702. In providing the service to the user, the UE's client application may receive request data from the host's host application and provide user data in response to the request data. The OTT connection 750 may transfer both the request data and the user data. The UE's client application may interact with the user to generate the user data that it provides to the host application through the OTT connection 750.

The OTT connection 750 may extend via the connection 760 between the host 702 and the network node 704 and via a wireless connection 770 between the network node 704 and the UE 706 to provide the connection between the host 702 and the UE 706. The connection 760 and the wireless connection 770, over which the OTT connection 750 may be provided, have been drawn abstractly to illustrate the communication between the host 702 and the UE 706 via the network node 704, without explicit reference to any intermediary devices and the precise routing of messages via these devices.

As an example of transmitting data via the OTT connection 750, in step 708, the host 702 provides user data, which may be performed by executing a host application. In some embodiments, the user data is associated with a particular human user interacting with the UE 706. In other embodiments, the user data is associated with a UE 706 that shares data with the host 702 without explicit human interaction. In step 710, the host 702 initiates a transmission carrying the user data towards the UE 706. The host 702 may initiate the transmission responsive to a request transmitted by the UE 706. The request may be caused by human interaction with the UE 706 or by operation of the client application executing on the UE 706.

The transmission may pass via the network node 704 in accordance with the teachings of the embodiments described throughout this disclosure. Accordingly, in step 712, the network node 704 transmits to the UE 706 the user data that was carried in the transmission that the host 702 initiated, in accordance with the teachings of the embodiments described throughout this disclosure. In step 714, the UE 706 receives the user data carried in the transmission, which may be performed by a client application executed on the UE 706 associated with the host application executed by the host 702.

In some examples, the UE 706 executes a client application which provides user data to the host 702. The user data may be provided in reaction or response to the data received from the host 702. Accordingly, in step 716, the UE 706 may provide user data, which may be performed by executing the client application. In providing the user data, the client application may further consider user input received from the user via an input/output interface of the UE 706. Regardless of the specific manner in which the user data was provided, the UE 706 initiates, in step 718, transmission of the user data towards the host 702 via the network node 704. In step 720, in accordance with the teachings of the embodiments described throughout this disclosure, the network node 704 receives user data from the UE 706 and initiates transmission of the received user data towards the host 702. In step 722, the host 702 receives the user data carried in the transmission initiated by the UE 706.

One or more of the various embodiments improve the performance of OTT services provided to the UE 706 using the OTT connection 750, in which the wireless connection 770 forms the last segment.

In an example scenario, factory status information may be collected and analyzed by the host 702. As another example, the host 702 may process audio and video data which may have been retrieved from a UE for use in creating maps. As another example, the host 702 may collect and analyze real-time data to assist in controlling vehicle congestion (e.g., controlling traffic lights). As another example, the host 702 may store surveillance video uploaded by a UE. As another example, the host 702 may store or control access to media content such as video, audio, VR, or AR which it can broadcast, multicast, or unicast to UEs. As other examples, the host 702 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 750 between the host 702 and the UE 706 in response to variations in the measurement results. The measurement procedure and/or the network functionality for reconfiguring the OTT connection 750 may be implemented in software and hardware of the host 702 and/or the UE 706. In some embodiments, sensors (not shown) may be deployed in or in association with other devices through which the OTT connection 750 passes; the sensors may participate in the measurement procedure by supplying values of the monitored quantities exemplified above, or by supplying values of other physical quantities from which software may compute or estimate the monitored quantities. The reconfiguring of the OTT connection 750 may include message format, retransmission settings, preferred routing, etc. ; the reconfiguring need not directly alter the operation of the network node 704. Such procedures and functionalities may be known and practiced in the art. In certain embodiments, measurements may involve proprietary UE signaling that facilitates measurements of throughput, propagation times, latency, and the like by the host 702. The measurements may be implemented in that software causes messages to be transmitted, in particular empty or ‘dummy’ messages, using the OTT connection 750 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Some example embodiments of the present disclosure are as follows:

### Group A Embodiments

Embodiment 1: A method performed by a User Equipment, UE, (100), the method comprising any one or more of the following:
receiving (106), from a first network node (102), a Quality of Experience, QoE, measurement configuration comprising one or more Public Land Mobile Network, PLMN, lists that indicate one or more equivalent PLMNs;
starting (108) an application session that is subject to the QoE measurement configuration;
starting (108) QoE measurements in accordance with the QoE measurement configuration;
transitioning (110) from connected state to idle state;
in the process of transitioning (112) from idle state to connected state with respect to a second network node (104),
   obtaining (112A) an PLMN ID of the second network node (104) (e.g., via receiving an RRC_setup message from the second network node (104);
   determining (112B), based on a comparison of the PLMN ID of the second network node (104) and PLMN IDs comprised in the one or more PLMN lists, whether the UE is to send, to the second network node (104), any one or more of the following:
      “an QoE report;”
      a QoE report availability indication;
      a network's instance of the QoE measurement configuration stored by the UE;
      an indication of availability of the network's instance of the QoE measurement configuration stored by the UE; and
operating (112C) in accordance with a result of the determining (112B).

Embodiment 2: The method of embodiment 1, wherein the one or more equivalent PLMNs are one or more PLMNs in which the UE is to execute QoE measurements in accordance with the QoE measurement configuration and/or one or more PLMNs to which the UE is permitted to send QoE reports and/or a stored network's instance of the QoE measurement configuration.

Embodiment 3: The method of embodiment 1 or 2, wherein:
determining (112B) comprises determining, based on the comparison of the PLMN ID of the second network node (104) and the PLMN IDs comprised in the one or more PLMN lists, that the PLMN of the second network node (104) is an equivalent PLMN; and
operating (112C) in accordance with the result of the determining comprises sending (112C), to the second network node (104), any one or more of the following:
   a QoE report for QoE measurements performed according to the QoE measurement configuration;
   a QoE report availability indication for a QoE report for QoE measurements performed according to the QoE measurement configuration;
   the network's instance of the QoE measurement configuration stored by the UE;
   an indication of availability of the network's instance of the QoE measurement configuration stored by the UE.

Embodiment 4: The method of embodiment 1 or 2, wherein: determining (112B) comprises determining, based on the comparison of the PLMN ID of the second network node (104) and the PLMN IDs comprised in the one or more PLMN lists, that the PLMN of the second network node (104) is a PLMN in which the UE is allowed to perform QoE measurements in accordance with the QoE measurement configuration; and operating (112C) in accordance with the result of the determining comprises sending (112C), to the second network node (104), the network's instance of the QoE measurement configuration stored by the UE or an indication of availability of the network's instance of the QoE measurement stored by the UE.

Embodiment 5: The method of embodiment 1 or 2, wherein: determining (112B) comprises determining, based on the comparison of the PLMN ID of the second network node (104) and the PLMN IDs comprised in the one or more PLMN lists, that the PLMN of the second network node (104) is a PLMN in which the UE is allowed to perform QoE measurements in accordance with the QoE measurement configuration but is not a PLMN to which the UE is allowed to send QoE reports for QoE measurements performed in accordance with the QoE measurement configuration; and operating (112C) in accordance with the result of the determining comprises performing QoE measurements in accordance with the QoE measurement configuration while in the connected state with respect to the second network node (104) but refraining from sending, to the second network node (104), a QoE report availability indication.

Embodiment 6: The method of embodiment 1 or 2, wherein: determining (112B) comprises determining, based on the comparison of the PLMN ID of the second network node (104) and the PLMN IDs comprised in the one or more PLMN lists, that the PLMN of the second network node (104) is a PLMN in which the UE is not allowed to perform QoE measurements in accordance with the QoE measurement configuration; and operating (112C) in accordance with the result of the determining comprises ceasing to perform QoE measurements in accordance with the QoE measurement configuration.

Embodiment 7: The method of any of embodiments 1 to 6, wherein the one or more PLMN lists comprise a single list of PLMNs in which the UE is allowed to execute QoE measurements in accordance with the QoE measurement configuration and is allowed to send associated QoE reports.

Embodiment 8: The method of any of embodiments 1 to 6, wherein the one or more PLMN lists comprise a first PLMN list containing PLMN IDs of PLMNs in which the UE is allowed to execute QoE measurements in accordance with the QoE measurement configuration and a second PLMN list containing PLMN IDs of PLMNs to which the UE is allowed to send associated QoE reports.

Embodiment 9: The method of any of embodiments 1 to 6, wherein the one or more PLMN lists comprise a first PLMN list containing PLMN IDs of PLMNs in which the UE is allowed to execute QoE measurements in accordance with the QoE measurement configuration and a second PLMN list containing PLMN IDs of PLMNs to which the UE is allowed to send associated QoE reports and the stored network's instance of the QoE measurement configuration.

Embodiment 10: The method of any of embodiments 1 to 6, wherein the one or more PLMN lists comprise a first PLMN list containing PLMN IDs of PLMNs in which the UE is allowed to execute QoE measurements in accordance with the QoE measurement configuration, a second PLMN list containing PLMN IDs of PLMNs to which the UE is allowed to send associated QoE reports, a third PLMN list containing PLMN IDs of PLMNs to which the UE is allowed to send the stored network's instance of the QoE measurement configuration.

Embodiment 11: The method of any of embodiments 1 to 6, wherein the one or more PLMN lists comprise a first PLMN list containing PLMN IDs of PLMNs in which the UE is allowed to send associated QoE reports and a second PLMN list containing PLMN IDs of PLMNs to which the UE is allowed to send the stored network's instance of the QoE measurement configuration.

Embodiment 12: The method of any of embodiments 1 to 6, wherein the one or more PLMN lists comprise a PLMN list containing PLMN IDs of PLMNs in which the UE is allowed to send associated QoE reports.

Embodiment 13: The method of any of embodiments 1 to 6, wherein the one or more PLMN lists comprise a PLMN list containing PLMN IDs of PLMNs in which the UE is allowed only to send associated QoE reports.

Embodiment 14: The method of any of embodiments 1 to 6, wherein the one or more PLMN lists comprise a PLMN list containing PLMN IDs of PLMNs in which the UE is allowed to execute QoE measurements in accordance with the QoE measurement configuration but not allowed to send associated QoE reports.

Embodiment 15: The method of any of embodiments 1 to 6, wherein the one or more PLMN lists comprise a PLMN list containing PLMN IDs of PLMNs in which the UE is allowed to send the stored network's instance of the QoE measurement configuration.

Embodiment 16: The method of any of embodiments 1 to 6, wherein the one or more PLMN lists comprise a PLMN list containing PLMN IDs of PLMNs in which the UE is allowed to only send the stored network's instance of the QoE measurement configuration.

Embodiment 17: The method of any of the previous embodiments, further comprising: providing user data; and forwarding the user data to a host via the transmission to the network node.

### Group B Embodiments

Embodiment 18: A method performed by a first network node (102), the method comprising any one or more of the following: sending (106), to a User Equipment, UE, (100), a Quality of Experience, QoE, measurement configuration comprising one or more Public Land Mobile Network, PLMN, lists that indicate one or more equivalent PLMNs; causing (110) the UE to transition from connected state to idle state.

Embodiment 19: The method of embodiment 18, wherein the one or more equivalent PLMNs are one or more PLMNs in which the UE is to execute QoE measurements in accordance with the QoE measurement configuration and/or one or more PLMNs to which the UE is permitted to send QoE reports and/or a stored network's instance of the QoE measurement configuration.

Embodiment 20: The method of any of the previous embodiments, further comprising: obtaining user data; and forwarding the user data to a host or a user equipment.

### Group C Embodiments

Embodiment 21: A user equipment comprising: processing circuitry configured to perform any of the steps of any of the Group A embodiments; and power supply circuitry configured to supply power to the processing circuitry.

Embodiment 22: A network node comprising: processing circuitry configured to perform any of the steps of any of the Group B embodiments; and power supply circuitry configured to supply power to the processing circuitry.

Embodiment 23: A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 24: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 25: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 26: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

Embodiment 27: The method of the previous embodiment, further comprising, at the network node, transmitting the user data provided by the host for the UE.

Embodiment 28: The method of any of the previous 2 embodiments, wherein the user data is provided at the host by executing a host application that interacts with a client application executing on the UE, the client application being associated with the host application.

Embodiment 29: A communication system configured to provide an over-the-top (OTT) service, the communication system comprising a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 30: The communication system of the previous embodiment, further comprising: the network node; and/or the UE.

Embodiment 31: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 32: The host of the previous 2 embodiments, wherein: the processing circuitry of the host is configured to execute a host application that receives the user data; and the host application is configured to interact with a client application executing on the UE, the client application being associated with the host application.

Embodiment 33: The host of the any of the previous 2 embodiments, wherein the initiating receipt of the user data comprises requesting the user data.

Embodiment 34: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Embodiment 35: The method of the previous embodiment, further comprising at the network node, transmitting the received user data to the host.

Embodiment 36: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the operations of any of the Group A embodiments to receive the user data from the host.

Embodiment 37: The host of the previous embodiment, wherein the cellular network further includes a network node configured to communicate with the UE to transmit the user data to the UE from the host.

Embodiment 38: The host of the previous 2 embodiments, wherein: the processing circuitry of the host is configured to execute a host application, thereby providing the user data; and the host application is configured to interact with a client application executing on the UE, the client application being associated with the host application.

Embodiment 39: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Embodiment 40: The method of the previous embodiment, further comprising: at the host, executing a host application associated with a client application executing on the UE to receive the user data from the host application.

Embodiment 41: The method of the previous embodiment, further comprising: at the host, transmitting input data to the client application executing on the UE, the input data being provided by executing the host application, wherein the user data is provided by the client application in response to the input data from the host application.

Embodiment 42: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Embodiment 43: The host of the previous embodiment, wherein the cellular network further includes a network node configured to communicate with the UE to transmit the user data from the UE to the host.

Embodiment 44: The host of the previous 2 embodiments, wherein: the processing circuitry of the host is configured to execute a host application, thereby providing the user data; and the host application is configured to interact with a client application executing on the UE, the client application being associated with the host application.

Embodiment 45: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Embodiment 46: The method of the previous embodiment, further comprising: at the host, executing a host application associated with a client application executing on the UE to receive the user data from the UE.

Embodiment 47: The method of the previous 2 embodiments, further comprising: at the host, transmitting input data to the client application executing on the UE, the input data being provided by executing the host application, wherein the user data is provided by the client application in response to the input data from the host application.

Those skilled in the art will recognize improvements and modifications to the embodiments of the present disclosure. All such improvements and modifications are considered within the scope of the concepts disclosed herein.

1. A method performed by a User Equipment (UE), the method comprising:
receiving, from a first network node, a Quality of Experience (QoE) measurement configuration comprising one or more Public Land Mobile Network (PLMN) lists that indicate one or more allowed PLMNs;
starting an application session that is subject to the QoE measurement configuration;
starting QoE measurements in accordance with the QoE measurement configuration;
transitioning from connected state to idle state;
in the process of transitioning from idle state to connected state with respect to a second network node;
obtaining a PLMN Identifier (ID) of the second network node;
determining, based on a comparison of the PLMN ID of the second network node and PLMN IDs comprised in the one or more PLMN lists, whether the UE is to send, to the second network node any one or more of the following:
an QoE report;
a QoE report availability indication;
a network's instance of the QoE measurement configuration stored by the UE; and
an indication of availability of the network's instance of the QoE measurement configuration stored by the UE; and
operating in accordance with a result of the determining.

2. The method of claim 1, wherein the one or more PLMN lists consist of a PLMN list in an area scope of the QoE measurement configuration.

3. The method of claim 2, wherein the PLMN ID of the second network node is not in the PLMN list, and the determining comprises determining that the UE is not to send a QoE report availability indication to the second network node based on the PLMN ID of the second network node not being in the PLMN list.

4. The method of claim 2, wherein the PLMN ID of the second network node is in the PLMN list such that the UE, and the determining comprises determining that the UE is to send a QoE report availability indication to the second network node based on the PLMN ID of the second network node being in the PLMN list.

5. The method of claim 2, wherein the PLMN ID of the second network node is in the PLMN list such that the UE, and the determining comprises determining that the UE is to send a QoE report to the second network node based on the PLMN ID of the second network node being in the PLMN list.

6. The method of claim 2, wherein the first network node is in a first PLMN, and the second network node is in a second PLMN that is different than the first PLMN.

7. The method of claim 6, wherein the PLMN ID of the second network node is not in the PLMN list such that the UE and the determining comprises determining that the UE is not to send a QoE report to the second network node

8. The method of claim 6, wherein the PLMN ID of the second network node is in the PLMN list, and the determining comprises determining that the UE is to send a QoE report availability indication to the second network node based on the PLMN ID of the second network node being in the PLMN list.

9. The method of claim 6, wherein the PLMN ID of the second network node is in the PLMN list, and the determining comprises determining that the UE is to send a QoE report to the second network node based on the PLMN ID of the second network node not being in the PLMN list.

10. The method of claim 1, wherein:
determining comprises determining, based on the comparison of the PLMN ID of the second network node and the PLMN IDs comprised in the one or more PLMN lists, that the PLMN of the second network node is an allowed PLMN; and
operating in accordance with the result of the determining comprises sending, to the second network node, any one or more of the following:
a QoE report for QoE measurements performed according to the QoE measurement configuration;
a QoE report availability indication for a QoE report for QoE measurements performed according to the QoE measurement configuration;
the network's instance of the QoE measurement configuration stored by the UE; and
an indication of availability of the network's instance of the QoE measurement configuration stored by the UE.

11. The method of claim 1, wherein:
determining comprises determining, based on the comparison of the PLMN ID of the second network node and the PLMN IDs comprised in the one or more PLMN lists, that the PLMN of the second network node is a PLMN in which the UE is allowed to perform QoE measurements in accordance with the QoE measurement configuration; and
operating in accordance with the result of the determining comprises sending, to the second network node, the network's instance of the QoE measurement configuration stored by the UE or an indication of availability of the network's instance of the QoE measurement stored by the UE.

12. The method of claim 1, wherein:
determining comprises determining, based on the comparison of the PLMN ID of the second network node and the PLMN IDs comprised in the one or more PLMN lists, that the PLMN of the second network node is a PLMN in which the UE is allowed to perform QoE measurements in accordance with the QoE measurement configuration but is not a PLMN to which the UE is allowed to send QoE reports for QoE measurements performed in accordance with the QoE measurement configuration; and
operating in accordance with the result of the determining comprises performing QoE measurements in accordance with the QoE measurement configuration while in the connected state with respect to the second network node but refraining from sending, to the second network node, a QoE report availability indication.

13-25. (canceled)

26. A User Equipment (UE) adapted to:
receive, from a first network node, a Quality of Experience (QoE) measurement configuration comprising one or more Public Land Mobile Network (PLMN) lists that indicate one or more allowed PLMNs;
start an application session that is subject to the QoE measurement configuration;
start QoE measurements in accordance with the QoE measurement configuration;
transition from connected state to idle state;
in the process of transitioning from idle state to connected state with respect to a second network node:
obtain an PLMN Identifier (ID) of the second network node; and
determine, based on a comparison of the PLMN ID of the second network node and PLMN IDs comprised in the one or more PLMN lists, whether the UE is to send, to the second network node, any one or more of the following:
an QoE report;
a QoE report availability indication;
a network's instance of the QoE measurement configuration stored by the UE; and
an indication of availability of the network's instance of the QoE measurement configuration stored by the UE; and
operate in accordance with a result of the determining

27-37. (canceled)

38. A method performed by a first network node, the method comprising:
sending, to a User Equipment (UE), a Quality of Experience (QoE) measurement configuration comprising one or more Public Land Mobile Network (PLMN) lists that indicate one or more allowed PLMNs; and
causing the UE to transition from connected state to idle state.

39. The method of claim 38, wherein the one or more allowed PLMNs are:
one or more PLMNs in which the UE is to execute QoE measurements in accordance with the QoE measurement configuration; and/or
one or more PLMNs to which the UE is permitted to send QoE reports and/or a stored network's instance of the QoE measurement configuration.

40. The method of claim 38, wherein the one or more PLMN lists consist of a PLMN list in an area scope of the QoE measurement configuration.

41. The method of claim 38, wherein the one or more PLMN lists comprise a single list of PLMNs in which the UE is allowed to execute QoE measurements in accordance with the QoE measurement configuration and is allowed to send associated QoE reports.

42. The method of claim 38, wherein the one or more PLMN lists comprise a first PLMN list containing PLMN IDs of PLMNs in which the UE is allowed to execute QoE measurements in accordance with the QoE measurement configuration and a second PLMN list containing PLMN IDs of PLMNs to which the UE is allowed to send associated QoE reports.

43. The method of claim 38, wherein the one or more PLMN lists comprise a first PLMN list containing PLMN IDs of PLMNs in which the UE is allowed to execute QoE measurements in accordance with the QoE measurement configuration and a second PLMN list containing PLMN IDs of PLMNs to which the UE is allowed to send associated QoE reports and the stored network's instance of the QoE measurement configuration.

44. The method of claim 38, wherein the one or more PLMN lists comprise a first PLMN list containing PLMN IDs of PLMNs in which the UE is allowed to execute QoE measurements in accordance with the QoE measurement configuration, a second PLMN list containing PLMN IDs of PLMNs to which the UE is allowed to send associated QoE reports, a third PLMN list containing PLMN IDs of PLMNs to which the UE is allowed to send the stored network's instance of the QoE measurement configuration.

45-51. (canceled)

52. A first network node adapted to:
send, to a User Equipment (UE), a Quality of Experience (QoE) measurement configuration comprising one or more Public Land Mobile Network (PLMN) lists that indicate one or more allowed PLMNs; and
cause the UE to transition from connected state to idle state.

53-54. (canceled)
